(19) United States
(12) Patent Application Publication
(10) Pub. No.: US 2021/0141130 A1
(43) Pub. Date: May 13, 2021

(54) HIGH-INDEX WAVEGUIDE FOR CONVEYING IMAGES

(71) Applicant: Facebook Technologies, LLC, Menlo Park, CA (US)

(72) Inventors: Hee Yoon Lee, Kirkland, WA (US); Pasi Saarikko, Kirkland, WA (US)

(21) Appl. No.: 16/681,137

(22) Filed: Nov. 12, 2019

(51) Int. Cl. G02B 5/18; G02B 27/10; G02B 27/42

(52) U.S. Cl. CPC G02B 5/1809; G02B 5/1828; G02B 27/4244; G02B 27/1006

(57) ABSTRACT

A waveguide display includes an image light source for emitting polychromatic image light, and a waveguide of high-index material for transmitting polychromatic image light to an eyebox. The waveguide has an input grating and an offset output grating. The output grating is configured so that ambient light diffracted by the output grating is directed away from the eyebox or out of at least a central portion of the field of view so as to lessen the appearance of visual artifacts.

### TECHNICAL FIELD

The present disclosure generally relates to optical display systems and devices, and in particular to waveguide displays and components therefor.

### BACKGROUND

Head mounted displays (HMD), helmet mounted displays, near-eye displays (NED), and the like are being used increasingly for displaying virtual reality (VR) content, augmented reality (AR) content, mixed reality (MR) content, etc. Such displays are finding applications in diverse fields including entertainment, education, training and biomedical science, to name just a few examples. The displayed VR/AR/MR content can be three-dimensional (3D) to enhance the experience and to match virtual objects to real objects observed by the user. Eye position and gaze direction, and/or orientation of the user may be tracked in real time, and the displayed imagery may be dynamically adjusted depending on the user's head orientation and gaze direction, to provide a better experience of immersion into a simulated or augmented environment.

Compact display devices are desired for head-mounted displays. Because a display of HMD or NED is usually worn on the head of a user, a large, bulky, unbalanced, and/or heavy display device would be cumbersome and may be uncomfortable for the user to wear.

Projector-based displays provide images in angular domain, which can be observed by a user's eye directly, without an intermediate screen or a display panel. An imaging waveguide may be used to carry the image in angular domain to the user's eye. The lack of a screen or a display panel in a projector display enables size and weight reduction of the display.

### BRIEF DESCRIPTION OF THE DRAWINGS

Embodiments disclosed herein will be described in greater detail with reference to the accompanying drawings which represent example embodiments thereof, in which like elements are indicated with like reference numerals, and wherein:

FIG. 1A is a schematic isometric view of a waveguide display system using a waveguide assembly for transmitting images to a user;

FIG. 1B is a schematic block diagram of a display projector of the waveguide display of FIG. 1A;

FIG. 2A is a schematic diagram illustrating the coupling of a first color channel into a waveguide and an input FOV for the first color channel;

FIG. 2B is a schematic diagram illustrating the coupling of a second color channel into the display waveguide of FIG. 2A and an input FOV of the second color channel;

FIG. 3A is a schematic diagram illustrating input and output FOVs of a display waveguide for a selected color channel;

FIG. 3B is a schematic side cross-section of a display waveguide with two out-coupler gratings at opposing faces;

FIG. 4 is a schematic plan view of a pupil-expanding waveguide illustrating an example layout of output-coupler gratings and an in-coupler aligned therewith;

FIG. 5 is a schematic k-space diagram illustrating the formation of a 2D FOV in an example embodiment of the waveguide of FIG. 4;

FIG. 6 is a graph illustrating the 2D FOV of the waveguide of FIG. 5 in the angle space;

FIG. 7 is a schematic side cross-sectional view of a display waveguide of FIG. 3B or 4 illustrating diffraction of ambient light into an eyebox by an output grating;

FIG. 8 is a schematic k-space diagram illustrating the diffraction of ambient light into a display FOV by an output grating of the display waveguide;

FIG. 9 is a schematic k-space diagram illustrating a condition when once-diffracted ambient light is captured by the waveguide;

FIG. 10 is a schematic k-space diagram illustrating a condition when an output grating diffracts ambient light outside of a central FOV;

FIG. 11 is a schematic side cross-sectional view of a display waveguide illustrating a maximum-angle ray capable of entering an eyebox from an output grating;

FIG. 12 is a k-space diagram illustrating the operation of a display waveguide of FIG. 4 for two different color channels;

FIG. 13A is a k-space diagram illustrating the formation of a FOV of an example display waveguide with the refraction index 2.6(?) for red light;

FIG. 13B is a k-space diagram illustrating the formation of a FOV of the example display waveguide of FIG. 13A for green light;

FIG. 13C is a k-space diagram illustrating the formation of a FOV of the example display waveguide of FIG. 13A for blue light;

FIG. 14 is a schematic side cross-sectional view of a two-waveguide stack with color-optimized waveguides;

FIG. 15A is a schematic plan view of a binocular NED with two pupil-expanding waveguides and in-couplers diagonally offset from exit pupils of the out-couplers;

FIG. 15B is a schematic vector diagram illustrating grating vectors for the example layout of FIG. 15A;

FIG. 16A is an isometric view of a head-mounted display of the present disclosure; and

FIG. 16B is a block diagram of a virtual reality system including the headset of FIG. 16A.

### DETAILED DESCRIPTION

In the following description, for purposes of explanation and not limitation, specific details are set forth, such as particular optical and electronic circuits, optical and electronic components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the example embodiments. All statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Note that as used herein, the terms “first”, “second”, and so forth are not intended to imply sequential ordering, but rather are intended to distinguish one element from another, unless explicitly stated. Similarly, sequential ordering of method or process steps does not imply a sequential order of their execution, unless explicitly stated.

Furthermore, the following abbreviations and acronyms may be used in the present document: HMD (Head Mounted Display); NED (Near Eye Display); VR (Virtual Reality); AR (Augmented Reality); MR (Mixed Reality); LED (Light Emitting Diode); FOV (Field of View); TIR (Total Internal Reflection). The terms “NED” and “HMD” may be used herein interchangeably.

Example embodiments may be described hereinbelow with reference to polychromatic light that is comprised of three distinct color channels. The color channel with the shortest wavelengths may be referred to as the blue (B) channel or color, and may represent the blue channel of an RGB color scheme. The color channel with the longest wavelengths may be referred to as the red (R) channel or color and may represent the red channel of the RGB color scheme. The color channel with wavelengths between the red and blue color channels may be referred to as the green (G) channel or color, and may represent the green channel of the RBG color scheme. The blue light or color channel may correspond to wavelength about 500 nanometers (nm) or shorter, the red light or color channel may correspond to wavelength about 600 nm or longer, and the green light or color channel may correspond to a wavelength range 500 nm to 565 nm. It will be appreciated however that the embodiments described herein may be adapted for use with polychromatic light comprised of any combination of two or more, or preferably three or more color channels, which may represent non-overlapping portions of a relevant optical spectrum.

An aspect of the present disclosure relates to a display system comprising a waveguide and an image light source coupled thereto, wherein the waveguide is configured to receive image light emitted by the image light source and to convey the image light received in a field of view (FOV) of the waveguide to an eyebox for presenting to a user. The waveguide may be configured to prevent undesired ambient light from being directed into the eye of the user. The term “field of view” (FOV), when used in relation to a display system, may define an angular range of light propagation supported by the system or visible to the user. A two-dimensional (2D) FOV may be defined by angular ranges in two orthogonal planes. For example, a 2D FOV of a NED device may be defined by two one-dimensional (1D) FOVs, which may be a vertical FOV, for example +\−20° relative to a horizontal plane, and a horizontal FOV, for example +\−30° relative to the vertical plane. With respect to a FOV of a NED, the “vertical” and “horizontal” planes or directions may be defined relative to the head of a standing person wearing the NED. Otherwise the terms “vertical” and “horizontal” may be used in the present disclosure with reference to two orthogonal planes of an optical system or device being described, without implying any particular relationship to the environment in which the optical system or device is used, or any particular orientation thereof to the environment.

An aspect of the present disclosure relates to a waveguide for conveying image light from an image light source to an eyebox with a target FOV spanning an angular range Γ. The waveguide may comprise a substrate for propagating the image light therein by total internal reflection, an input coupler supported by the substrate and configured to couple the image light into the waveguide, and an output coupler supported by the substrate and configured to couple the image light out of the waveguide for propagating toward the eyebox. The output coupler may comprise a first output grating having a pitch p₁ that does not exceed

$$\frac{λ}{1 + sin ( 0.8 \cdot Γ \text{/} 2 )} ,$$

where λ may be a shortest wavelength of a visible light.

In some implementations the input coupler comprises an input grating having a pitch that does not exceed p₁.

In some implementations p₁ may be equal or smaller than

$$\frac{λ}{1 + sin ( Γ \text{/} 2 )} .$$

In some implementations the substrate may have a refractive index of at least 2.3. In some implementations the substrate may have a refractive index of at least 2.4. In some implementations the substrate may have a refractive index of at least 2.5.

In some implementations the output coupler may further comprise a second output grating configured to cooperate with the first output grating to diffract the image light out of the waveguide, wherein the second output grating may have a pitch that does not exceed p. In some implementations the first output grating and the second output grating cooperate for diffracting the image light out of the waveguide at an output angle equal to an angle of incidence thereof upon the waveguide. In some implementations the first and second output gratings may be disposed at opposite faces of the waveguide.

In some implementations the waveguide may be configured for conveying to the eyebox at least one of a red color (R) channel and a green color (G) channel, and the pitch p may be equal or smaller than

$$\frac{λ}{1 + sin ( 0.8 \cdot Γ \text{/} 2 )}$$

where λ may be a wavelength of blue light. In some implementations the wavelength λ may be smaller than 500 nm.

In some implementations the pitch p may be equal or less than 300 nm. In some implementations the pitch p may be equal or less than 280 nm.

In some implementations wherein the eyebox extends over a length 2a in a first direction, and wherein the first output grating extends over a length 2b in the first direction and is disposed at a distance d from the eyebox; the pitch p may satisfy the condition

$$p \leq \frac{λ}{1 + sin ( α )}$$

wherein α=atan[(b+a)/d].

An aspect to the present disclosure relates to a near-eye display (NED) device comprising: a light source configured to emit image light comprising a plurality of color channels, and a first waveguide optically coupled to the light source and configured to convey a portion of the image light from the light source to an eyebox within a target field of view (FOV) spanning an angular range Γ. The first waveguide may comprise an input coupler for receiving the portion of the image light, and an output coupler for coupling said portion out of the first waveguide toward the eyebox. The output coupler may comprise a first output grating having a pitch p₁ that does not exceed

$$\frac{λ}{1 + sin ( 0.8 \cdot Γ \text{/} 2 )} ,$$

where λ is a wavelength of a shortest-wavelength color channel of the image light.

In some implementations of the NED device, the first waveguide may comprise dielectric material with an index of refraction of at least 2.3. In some implementations of the NED device, the first waveguide may comprise dielectric material with an index of refraction of at least 2.4. In some implementations of the NED device, the waveguide may comprise dielectric material with an index of refraction of at least 2.5.

In some implementations of the NED device, the output coupler may further comprise a second output grating configured to cooperate with the first output grating to diffract the image light out of the first waveguide at an output angle equal to an incidence angle of the image light upon the input coupler, wherein the second output grating has a pitch not exceeding p₁.

In some implementations of the NED device, λ is a wavelength of blue light, and the first waveguide may be configured to convey to the eyebox at least one of a red color channel of the image light or a green color channel of the image light.

In some implementations of the NED device, λ≤500 nm, and the first waveguide may be configured to convey to the eyebox a red color channel of the image light with wavelengths equal or longer than 600 nm.

In some implementations the NED device may comprise a waveguide stack including the first waveguide, wherein each waveguide of the waveguide stack comprises an output grating with a pitch of at most p₁.

In some implementations the image light may comprise RGB light comprising a red color channel, a green color channel, and a red color channel, and the first waveguide is configured to convey to the eyebox each of the red, green, and blue color channels.

An aspect of the disclosure relates to a waveguide for conveying image light comprising a plurality of color channels from an image light source to an eyebox, the waveguide comprising: a substrate for propagating the image light therein by total internal reflection; an input coupler supported by the substrate for receiving the image light; and, an output coupler supported by the substrate for coupling the image light out of the waveguide toward the eyebox. The output coupler may comprise a first output grating having a pitch p that does not exceed 300 nm. In some implementations the substrate may have an index of refraction of at least 2.3. In some implementations the substrate may have an index of refraction of at least 2.4. In some implementations the substrate may have an index of refraction of at least 2.5. In some implementations the waveguide may be configured for conveying to the eyebox at least one of a red color (R) channel of the image light and a green color (G) channel of the image light.

An aspect of the present disclosure relates to a waveguide for conveying image light from an image light source to an eyebox with a target field of view (FOV) spanning an angular range Γ. The waveguide may comprise a substrate for propagating the image light therein by total internal reflection, an input coupler supported by the substrate and configured to couple the image light into the waveguide, and an output coupler supported by the substrate and configured to couple the image light out of the waveguide for propagating toward the eyebox. The output coupler may comprise a first output grating having a pitch p₁ does not exceed

$$\frac{λ}{1 + sin ( 0.8 \cdot Γ \text{/} 2 )}$$

where λ is a wavelength of blue light. In some implementations the pitch p₁ does not exceed

$$\frac{λ}{1 + sin ( Γ \text{/} 2 )} .$$

In some implementations λ may be 500 nm. In some implementations λ may be 450 nm.

Example embodiments of the present disclosure will now be described with reference to a waveguide display. Generally a waveguide display may include an image light source such as an electronic display assembly, a controller, and an optical waveguide configured to transmit image light from the electronic display assembly to an exit pupil for presenting images to a user. The image light source may also be referred to herein as a display projector, an image projector, or simply as a projector. Example display systems that may incorporate a waveguide display, and wherein features and approaches disclosed here may be used, include, but not limited to, a near-eye display (NED), a head-up display (HUD), a head-down display, and the like.

With reference to FIGS. 1A and 1B, there is illustrated a waveguide display 100 in accordance with an example embodiment. The waveguide display 100 includes an image light source 110, a waveguide assembly 120, and may further include a display controller 155. The image light source 110 is configured to generate image light 111. In some embodiments the image light source 110 may be in the form of, or include, a scanning projector.

In some embodiments the image light source 110 may include a pixelated electronic display 114 that may be optically followed by an optics block 116. The electronic display 114 may be any suitable electronic display configured to display images, such as for example but not limited to a liquid crystal display (LCD), an organic light emitting display (OLED), an inorganic light emitting display (ILED), an active-matrix organic light-emitting diode (AMOLED) display, or a transparent organic light emitting diode (TOLED) display. In some embodiment the electronic display 114 may be in the form of a linear array of light sources, such as light-emitting diodes (LED), laser diodes (LDs), or the like, with each light source configured to emit polychromatic light. In some embodiments it may include a two-dimensional (2D) pixel array, with each pixel configured to emit polychromatic light.

The optics block 116 may include one or more optical components configured to suitably condition the image light emitted by the electronic display 114. This may include, without limitation, expanding, collimating, correcting for aberrations, and/or adjusting the direction of propagation of the image light emitted by the electronic display 114, or any other suitable conditioning as may be desired for a particular system and electronic display. The one or more optical components in the optics block 116 may include, without limitations, one or more lenses, mirrors, apertures, gratings, or a combination thereof. In some embodiments the optics block 116 may include one or more adjustable elements operable to scan the beam of light emitted by the electronic display 114 with respect to it propagation angle.

The waveguide assembly 120 may be in the form of, or include, a waveguide 123 comprising an in-coupler 130 and an out-coupler 140. In some embodiments a waveguide stack composed of two or more waveguides stacked one over another may be used in place of the waveguide 123. The input coupler 130 may be disposed at a location where it can receive the image light 111 from the image light source 110. The input coupler 130, which may also be referred to herein as the in-coupler 130, is configured to couple the image light 111 into the waveguide 123, where it propagates toward the output coupler 140. The output coupler 140, which may also be referred to herein as the out-coupler, may be offset from the input coupler 130 and configured to de-couple the image light from the waveguide 123 for propagating in a desired direction, such as for example toward a user's eye 166. The out-coupler 140 may be greater in size than the in-coupler 130 to expand the image beam in size as it leaves the waveguide, and to support a larger exit pupil than that of the image light source 110. In some embodiments the waveguide assembly 120 may be partially transparent to outside light, and may be used in AR applications. The waveguide 123 may be configured to convey a 2D FOV from an input coupler 130 to the output coupler 140, and ultimately to the eye 166 of the user. Here and in the following description a Cartesian coordinate system (x,y,z) is used for convenience, in which the (x,y) plane is parallel to the main faces of the waveguide assembly 120 through which the assembly receives and/or outputs the image light, and the z-axis is orthogonal thereto. The 2D FOV of waveguide 123 may be defined by a 1D FOV in the (y,z) plane and a 1D FOV in the (x,z) plane, which may also be referred to as the vertical and horizontal FOVs, respectively.

Referring now to FIGS. 2A and 2B, they schematically illustrate the coupling of light of two different wavelengths into a waveguide 210, which may represent the waveguide 123 of waveguide assembly 120, or any waveguide of a waveguide stack that may be used in place of the waveguide 123. The wavelength λ of incident light in FIG. 2A may be different, for example smaller, than the wavelength of incident light in FIG. 2B. FIG. 2A may represent, for example, the operation of waveguide 210 for green light, while FIG. 2B may for example represent the operation of waveguide 210 for red light.

Waveguide 210 may be a slab waveguide formed of a substrate 205, which may be for example in the form of a thin plate of an optical material that is transparent in visible light, such as glass or suitable plastic or polymer as non-limiting examples. Opposing main faces 211, 212 of waveguide 210, through which image light may enter or leave the waveguide, may be nominally parallel to each other. The refractive index n of the substrate material may be greater than that of surrounding media, and may be for example in the range of 1.4 to 2.6. In some embodiments, high-index materials having an index of refraction equal or greater than about 2.3 may be used for the substrate 205. In some embodiments these materials may have an index of refraction n greater than about 2.4. In some embodiments these materials may have an index of refraction n greater than about 2.5. Non-limiting examples of such materials are lithium niobate (LiNbO3), titanium dioxide (TiO2), galium nitirde (GaN), aluminum nitiride (AlN), silicon carbide (SiC), CVD diamond, zinc sulfide (ZnS).

An in-coupler 230 may be provided in or upon the waveguide 210 and may be in the form of one or more diffraction gratings. An out-coupler 240, which may also be in the form of one or more diffraction gratings, is laterally offset from the in-coupler 230, for example along the y-axis. In the illustrated embodiment the out-coupler 240 is located at the same face 211 of the waveguide 210 as the in-coupler 130, but in other embodiments it may be located at the opposite face 212 of the waveguide. Some embodiments may have two input gratings that may be disposed at opposing faces 211, 212 of the waveguide, and/or two output gratings that may be disposed at opposing faces 211, 212 of the waveguide. The gratings embodying couplers 230, 240 may be any suitable diffraction gratings, including volume and surface-relief gratings, such as for example blaze gratings. The gratings may also be volume holographic gratings. In some embodiments they may be formed in the material of the waveguide itself. In some embodiments they may be fabricated in a different material or materials that may be affixed to a face or faces of the waveguide at desired locations. In the example embodiment illustrated in FIGS. 2A and 2B, the in-coupler 230 is embodied with a diffraction grating operating in transmission, while the out-coupler 240 is embodied with a diffraction grating operating in reflection.

The in-coupler 230 may be configured to provide the waveguide 210 with an input FOV 234, which may also be referred to herein as the acceptance angle. The input FOV 234, which depends on the wavelength, defines a range of angles of incidence a for which the light incident upon the in-coupler 230 is coupled into the waveguide and propagates toward the out-coupler 240. In the context of this specification, “coupled into the waveguide” means coupled into the guided modes of the waveguide or modes that have suitably low radiation loss, so that light coupled into the waveguide becomes trapped therein by total internal reflection (TIR), and propagates within the waveguide with suitably low attenuation until it is engaged by an out-coupler. Thus waveguide 210 may trap light of a particular wavelength λ by means of TIR, and guide the trapped light toward the out-coupler 240, provided that the angle of incidence of the light upon the in-coupler 230 from the outside of the waveguide is within the input FOV 234 of the waveguide 210. The input FOV 234 of the waveguide is determined at least in part by a pitch p of the in-coupler grating 230 and by the refractive index n of the waveguide. For a given grating pitch p, the first-order diffraction angle β of the light incident upon the grating 230 from the air at an angle of incidence α in the (y, z) plane may be found from a diffraction equation (1):

n·sin(β)+sin(α)=λ/p. (1)

Here the angle of incidence α and the diffraction angle β are positive if corresponding rays are on the same side from the normal 207 to the opposing faces 211, 212 of the waveguide and is negative otherwise. Equation (1) may be easily modified for embodiments in which the waveguide 210 is surrounded by cladding material with refractive index n_{c}>1. Equation (1) holds for rays of image light with a plane of incidence normal to the groves of the in-coupler grating, i.e. when the grating vector of the in-coupler grating lies within the plane of incidence of image light.

The TIR condition for the diffracted light within the waveguide, referred hereinafter as the in-coupled light, is defined by the TIR equation (2):

n·sin(β)≥1, (2)

where the equality corresponds to a critical TIR angle β_{c}=asin(1/n). The input FOV 234 of the waveguide spans between a first FOV angle of incidence α₁ and a second FOV angle of incidence α₂, which may be referred to herein as the FOV edge angles. The first FOV angle of incidence α₁ corresponding to the right-most incident ray 111b in FIG. 2A is defined by the critical TIR angle β_{c} of the in-coupled light, i.e. light trapped within the waveguide:

$${α}_{1} = a sin ( \frac{λ}{p} - 1 ) , \qquad ( 3 )$$

The second FOV angle of incidence α₂, corresponding to the left-most incident ray 111a in FIG. 2A, is defined by a limitation on a maximum angle βₘₐₓ of the in-coupled light:

$${α}_{2} = ( \frac{λ}{p} - n \cdot sin ( {β}_{max} ) ) , \qquad ( 4 )$$

The width w=|α₁−α₂| of the input 1D FOV of the waveguide 210 at a particular wavelength can be estimated from equations (3) and (4). Generally the input FOV of a waveguide increases as the refractive index of the waveguide increases relative to that of the surrounding media. By way of example, for a substrate of index n surrounded by air and for βₘₐₓ=75°, λ/p=1.3, the width w of the input FOV of the waveguide is about 26° for n=1.5, about 43° for n=1.8, and is about 107° for n=2.4.

As can be seen from equations (3) and (4), the input FOV 234 of waveguide 210 is a function of the wavelength λ of input light, so that the input FOV 234 shifts its position in the angle space as the wavelength changes; for example, it shifts towards the out-coupler 240 as the wavelength increases. Thus it can be challenging to provide a sufficiently wide FOV for polychromatic image light.

Referring to FIG. 3A, light coupled into the waveguide 210 by the in-coupler 230 propagates in the waveguide toward the out-coupler 240. The out-coupler 240 is configured to re-direct at least a portion of the in-coupled light out of the waveguide 210 at an angle or angles within an output FOV 244 of the waveguide, which is defined at least in part by the out-coupler 240. An overall FOV of the waveguide, i.e. the range of incidence angles α that may be conveyed to the viewer by the waveguide, may be affected by both the in-coupler 230 and the out-coupler 240.

In some embodiments the gratings embodying the in-coupler 230 and the out-coupler 240 may be configured so that the vector sum of their grating vectors k_{g} is equal to substantially zero:

|Σk_{g}|≅0. (5)

Here the summation in the left hand side (LHS) of equation (5) is performed over grating vectors k_{g} of all gratings that diffract the input light traversing the waveguide, including the one or more gratings of the in-coupler 230, and the one or more gratings of the out-coupler 230. A grating vector k_{g} is a vector that is directed normally to the equal-phase planes of the grating, i.e. its “grooves”, and which magnitude is inversely proportional to the grating pitch p, |k_{g}|=2 π/p. Under conditions of equation (5), rays of the image light exit the waveguide by means of the out-coupler 240 at the same angle at which they entered the in-coupler 230, provided that the waveguide 210 is an ideal slab waveguide with parallel opposing faces 211, 212, and the FOV of the waveguide is defined by its input FOV. In practical implementations the equation (5) will hold with some accuracy, within an error threshold that may be allowed for a particular display system. In an example embodiment with a single one-dimensional (1D) input grating and a 1D output grating, the grating pitch of the out-coupler 240 may be substantially equal to the grating pitch of the in-coupler 230.

FIG. 3B illustrates an embodiment in which the out-coupler 240 includes two diffraction gratings 241, 242 that are disposed at opposing faces of the waveguide. In such embodiments the in-coupled light 211a may exit the waveguide as output light 221 after being sequentially diffracted by the diffraction gratings 241 and 242. In some embodiments, the grating vectors g₁ and g₂ of the diffraction gratings 241, 242 may be directed at an angle to each other. In at least some embodiments they may be selected so that (g₀+g₁+g₂)=0, where g₀ is the grating vector of the in-coupler 230.

FIG. 4 illustrates, in a plan view, a display waveguide 410 with an in-coupler 430 and an out-coupler 440. The in-coupler 430 may be in the form of an input diffraction grating with a grating vector g₀ directed generally toward the out-coupler 440. The out-coupler 440 is comprised of two output diffraction gratings 441 and 442 with grating vectors g₁ and g₂ oriented at an angle to each other. In some embodiments gratings 441 and 442 may be linear diffraction gratings formed at opposing faces of the waveguide. In some embodiments they may superimposed upon each other at either face of the waveguide, or in the volume thereof, to form a 2D grating. Light 401 incident upon the in-coupler 430 within a FOV of the waveguide may be coupled by the in-coupler 430 into the waveguide to propagate toward the out-coupler 440, expanding in size in the plane of the waveguide, as illustrated by in-coupled rays 411a and 411b. The gratings 441, 442 are configured so that consecutive diffractions off each of them re-directs the in-coupled light out of the waveguide. Rays 411a may be rays of in-coupled light that, upon entering the area of the waveguide where the out-coupler 440 is located, are first diffracted by the first grating 441, and then are diffracted out of the waveguide by the second grating 442 after propagating some distance within the waveguide. Rays 411b may be rays of the in-coupled light that are first diffracted by the second grating 442, and then are diffracted out of the waveguide by the first grating 441. An exit pupil 450 of the waveguide, which may also be referred to as an eyebox projection area 450, is an area where the out-coupled light has optimal characteristics for viewing, for example where it has desired dimensions. The eyebox projection area 450 may be located at some distance from the in-coupler 430.

FIG. 5 illustrates the transformation of light in display waveguide 410 in a k-space, namely in a (kₓ, k_{y}) plane, where kₓ and k_{y} denote coordinates of the light wavevector k=(kₓ, k_{y}) in projection upon the plane of the waveguide:

$${k}_{x} = \frac{2 π n}{λ} sin ( {θ}_{x} ) , and {k}_{y} = \frac{2 π n}{λ} sin ( {θ}_{y} ) . \qquad ( 6 )$$

Here n is the refractive index of the substrate where light is propagating, and the angles θₓ and θ_{y} define the direction of light propagation in the plane of the waveguide in projection on the x-axis and y-axis, respectively. These angles may also represent the coordinates of angle space in which a 2D FOV of the waveguide may be defined. The (kₓ, k_{y}) plane may be referred to herein as the k-space, and the 2D wavevector k=(kₓ, k_{y}) as the k-vector.

In the k-space, the in-coupled light may be graphically represented by a TIR ring 500. The TIR ring 500 is an area of the k-space bounded by a TIR circle 501 and a maximum-angle circle 502. The TIR circle 501 corresponds to the critical TIR angle β_{c}. The maximum-angle circle 502 corresponds to a maximum propagation angle βₘₐₓ for in-coupled light. States within the TIR circle 501 represent uncoupled light, i.e. the in-coming light that is incident upon the in-coupler 430 or the light coupled out of the waveguide by one of the out-coupler gratings 441, 442. Without normalization, the radius r_{TIR} of the TIR circle 501 and the radius rₘₐₓ of the outer circle 502 may be defined by the following equations:

$${r}_{TIR} = \frac{2 π}{λ} , {r}_{max} = \frac{2 π n}{λ} sin ( {β}_{max} ) \qquad ( 7 )$$

The greater the refractive index n, the broader is the angular range of input light of a wavelength λ that can be coupled into the waveguide.

Arrows labeled g₀, gᵢ, and g₂ in FIG. 5 represent the grating vectors of the in-coupler 430, the first out-coupler grating 441, and the second out-coupler grating 442, respectively. In the figure they form two closed triangles describing two possible paths in the k-space along which the incoming light may return to the same state in the k-space after being diffracted once by each of the three gratings, thereby preserving the direction of propagation in the angle space from the input to the output of the waveguide. Each diffraction may be represented as a shift in the (kₓ,k_{y}) plane by a corresponding grating vector. Areas 520, 530 in combination represent the FOV of the waveguide in the (kₓ,k_{y}) plane, and may be referred to as the first and second partial FOV areas, respectively. They are defined by the in-coupler and out-coupler gratings and the refractive index of the waveguide, and represent all k-vectors of light stays trapped within the waveguide (the TIR ring 500) after consecutive diffractions upon the input grating 430 and one of the output gratings 441, 442, and returns to a same (kₓ,k_{y}) location in the interior of the TIR circle 501 after a subsequent diffraction upon the other of the two output gratings. The first partial FOV area 520 may be determined by identifying all (kₓ, k_{y}) states which are imaged to itself by consecutive diffractions upon the input grating 430, the first output grating 441, and the second output grating 442, each of which may be represented as a shift in the (kₓ,k_{y}) plane by a corresponding grating vector. The second partial FOV area 530 may be determined by identifying all (kₓ, k_{y}) states which are imaged to itself by consecutive diffractions upon the input grating 430, the second output grating 442, and the first output grating 441.

FIG. 6 illustrates the first and second partial FOVs 520, 530 in a 2D angle space, with the horizontal and vertical axes representing the angles of incidence θₓ and θ_{y} of input light in the x-axis and y-axis directions, respectively, both in degrees. The (0,0) point corresponds to normal incidence upon the in-coupler. In combination partial FOVs 520, 530 define a full FOV 550 of the waveguide at the wavelength λ which encompasses all incident rays of input light of the selected color or wavelength that may be conveyed to a user. A rectangular area 555 which fits within the full FOV 550 may define a monochromatic FOV of the waveguide that may be useful in a display.

The position, size, and shape of each partial FOV 520, 530 in the angle space, and thus the full 2D FOV of the waveguide, depends on the wavelength λ of the input light, on the ratios of pitches p₀, p₁, and p₂ of the input and output gratings to the wavelength of incoming light X, and on the relative orientation of the gratings. Thus, the 2D FOV of the waveguide may be suitably shaped and positioned in the angle space for a particular color channel or channels by selecting the pitch sizes and the relative orientation of the gratings. In some embodiments of waveguide 410, the output gratings 441, 442 may have the same pitch, p₁=p₂ and be symmetrically oriented relative to the input grating. In such embodiments the grating vectors g₁, g₂ of the first and second output gratings may be oriented at angles of +\−ϕ relative to the grating vector g₀ of the in-coupler. By way of non-limiting example, the grating orientation angle ϕ may be in the range of 50 to 70 degrees, for example 60 to 66 degrees, and may depend on the refractive index of the waveguide. FIG. 6 illustrates the FOV of an example waveguide with the refractive index n=1.8, ϕ≅60°, and p₁=p₂=p₃=p, with p/λ selected to center the FOV 555 at normal incidence.

In some embodiments a display waveguide of a NED, such as the display waveguide 410 of FIG. 4, may redirect ambient light into the eyebox in a manner that results in undesirable visual artifacts, such as the appearance of a rainbow-type patterns that may be visible to the user of the NED. This ambient light leakage may be caused by a diffraction of ambient light upon one of the out-coupler gratings, such as either of the gratings 442 and 441 of waveguide 410 of FIG. 4 or either of the gratings 241 and 242 of waveguide 210 of FIG. 3B.

FIG. 7 illustrates an example ray 701 of ambient light incident upon a display waveguide 710 where output gratings 741 and 742 are located. An input grating 730 and the output gratings 741, 742 may be for example as described above with reference to gratings 430, 442 and 441 of waveguide 410 of FIG. 4 or gratings 230, 241 and 242 of waveguide 210 of FIG. 3B. In the illustrated example ray 701 impinges upon an outer face of waveguide 710 tangentially at a large angle of incidence α₁ and is diffracted by the output grating 841 toward the eyebox 744 with an incidence angle α₂ in the waveguide, as illustrated by the diffracted ray B. If the diffracted ray 703 satisfies TIR, it will be captured by the waveguide and will not reach the eyebox. However if the second incidence angle α₂ is small enough, the diffracted ray 703 of the ambient light may reach the eyebox 744 and result in the appearance of visual artifacts in the FOV of the viewer. Different color components of white ambient light may be diffracted at slightly different angles, which may lead to the appearance of a rainbow-like visual artifact.

FIG. 8 illustrates a vector representation of this process in the (kₓ, k_{y}) plane described above with reference to FIG. 5. Here again the area within the TIR circle 501 represents uncoupled light, the outer circle 502 represents a target maximum propagation angle βₘₐₓ of image light within the waveguide, and vectors g₁ and g₂ are the grating vectors of the output gratings 741, 742. The k-vectors inside the inner TIR circle 501 span 180 degrees of propagation angle of uncoupled light in both the x-axis and y-axis directions, with the center of the TIR circle 501 corresponding to a normal incidence, or 0 degrees. Dots labeled “A” and “B” indicate the locations of the k-vectors of the incident ambient ray 701 and the diffracted ray 703, respectively. The location “A” just within the TIR circle 501 indicates that ray 701 is a “glancing” ray with the incidence angle α₁ close to 90 degrees. If the length of the grating vector g₁ of the output grating 741 is smaller than the diameter D=2·r_{TIR} of the TIR circle 501, location “B” is within the TIR circle 501, indicating that the diffracted ray 703 will be transmitted through the waveguide and may reach the eyebox 744.

Referring now to FIG. 9, the leakage of ambient light of wavelength λ into the eyebox by means of a single diffraction off an output grating may be eliminated if the grating vectors g₁, g₂ of the output gratings exceed in length the diameter D=2r_{TIR} of the TIR circle 501. From the first of equations (7), one obtains a corresponding condition (8) for the grating pitch:

$${p}_{i} \leq \frac{λ}{2} \qquad ( 8 )$$

where pᵢ is the grating's pitch, which defines the length g of the grating vector gᵢ as g=2π/pᵢ, i=1, 2. If condition (8) is fulfilled, a single diffraction of even a glancing ray of ambient light will trap that ray within the waveguide by TIR, thereby preventing the ambient light of wavelengths equal or greater than λ from being diffracted by the output gratings toward the eyebox at an angle different from its angle of incidence.

Referring to FIG. 10, in some embodiments it may be sufficient to prevent ambient light from being diffracted through the waveguide within a certain FOV, for example in an angular range from −γ to +γ, where the angle γ may be referred to as the maximum rainbow-free (MRF) angle; a corresponding range of the in-plane k-vectors is indicated in FIG. 10 by an area 571 within a dashed circle 507 of radius k_{γ}≅2π sin(γ)/λ. The area 571 of the in-plane k-vectors of uncoupled light may correspond to, or encompass within itself, a target FOV of the NED, or at least a pre-defined central portion thereof. In order for the ambient light ray 703 striking the waveguide at a glancing angle, e.g. as indicated by location “A” next to the TIR circle 501, to be diffracted outside of the leakage-free area 571, the length g of the grating vectors gᵢ of the out-couplers should exceed the sum of the radius r_{TIR} of the TIR circle 501 and the length k_{γ} of the k-vector corresponding to the MRF angle γ:

$${g}_{i} \geq \frac{2 π}{λ} ( 1 + sin ( γ ) )$$

where i=1 or 2. This condition provides a corresponding condition (9) on the pitch pᵢ of the out-coupler gratings 741, 742:

pᵢ≤ξλ (9)

where scaling parameter ξ<1 is defined by the MRF angle γ:

$$ξ = \frac{1}{1 + sin ( γ )} \qquad ( 10 )$$

Referring to FIG. 11, in some embodiments the MRF angle γ in equation (9) may be defined by the geometry of the NED using the waveguide, such as the size and position of output grating 741 relative to the eyebox 747. The viewing geometry may ultimately limit the angular range of diffracted rays 777 that could enter the eyebox 747 from the output grating 741, and hence could potentially be visible to the user wearing the NED. FIG. 11 illustrates an example embodiment in which the output grating 741 of width 2a is centered against the eyebox 747 of width 2b, with the eye relief distance d. The width 2a may represent a length of the output grating 741 in a specific direction, for example along a horizontal axis of a NED, or along a dimension of maximum grating size. The width 2b may represent a length of the eyebox 747 in the same direction. In this case the maximum angle θₘ of the diffracted ray 777 that can enter the eyebox 747 may be estimated as

$${θ}_{m} = a tan ( \frac{a + b}{d} ) , \qquad ( 11 )$$

and in equation (9) the MRF angle γ≅θₘ. By way of example, for a=35 mm, b=10 mm, d=7 mm, θₘ≅83°. For a smaller output coupler with a=20 mm and a condition that the ambient ray does not reach the center of the eyebox, so that b may be set to 0, equation (11) yields θₘ≅76°.

In some embodiments it may be sufficient to prevent ambient light from appearing within a target FOV that is supported by the HMD. In such embodiments, MRF angle γ may be defined by a characteristic FOV width Γ of the NED, for example its diagonal width. FIG. 10 illustrates an example rectangular FOV 577 with the diagonal width of 2γ. In some embodiments it may be sufficient to prevent ambient light from appearing only in a portion of the target FOV of the HMD, for example in the center 80% or 90% of it. In such embodiments, equation (10) may be re-written in the form

$$ξ = \frac{1}{1 + sin ( c \cdot Γ \text{/} 2 )} \qquad ( 12 A )$$

which corresponds to a condition

$${p}_{i} \leq \frac{λ}{1 + sin ( c \cdot Γ \text{/} 2 )} \qquad ( 12 B )$$

Here Γ is a characteristic width of a target FOV of the display, and c is a fraction of the target FOV that is to remain free of the ambient light leakage described above. In embodiments configured to support a rectangular 2D FOV, Γ may be the diagonal width of its 2D FOV. In some embodiments it may be sufficient that the central 90% of the target diagonal FOV is free of the ambient leakage, corresponding to c=0.9. In some embodiments it may be sufficient that the central 80% of the target diagonal FOV is free of the ambient leakage, corresponding to c=0.8. By way of example, the supported 2D FOV may be 40 by 60 degrees, and Γ may be about 72 degrees, which corresponds to p≤0.63λ, for c=1, and p≤0.67λ, for c=0.8, or for λ=450 nm (blue light) p≤280 nm and p≤300 nm, respectively. In some embodiments the output gratings may be configured with pitch pᵢ that satisfies equation (12B) with parameter c greater than 1, for example c=1.1 or 1.2, so that the leakage of ambient light with wavelengths equal or greater than λ is suppressed in an angular range broader than the target FOV of the display.

Conditions (8) to (12B) limit the pitch of the output gratings for a specific wavelength of ambient light. If any one of them is fulfilled for the shortest wavelengths of a visible spectrum of ambient light that may be incident upon the waveguide, it will also be fulfilled for all longer wavelength of the visible spectrum. The term “visible spectrum” may refer here to a portion of a spectrum of electromagnetic radiation that is visible to a typical human eye under normal lighting conditions, such as 3 candelas per square meter (cd/m2) and higher (photopic vision), which spans from about 420 nm to about 700 nm. For the purpose of lessening the appearance of the rainbow artifact, the shortest wavelength of the visible spectrum, which may also be referred to as the shortest wavelength of visible light, may correspond to the wavelength of about 420 nm. In some embodiments it may be sufficient that one or more of the conditions (8) to (12B) is fulfilled for a wavelength of the blue color range of visible light, where the photopic vision sensitivity of the human eye falls to less than 1-5% of its peak value at 555 nm, e.g. for λ≥450 nm. In some embodiments it may be therefore sufficient that condition (9) with the scaling factor defined according to equations (8), (10), (11), or (12A) is fulfilled for blue light. In some embodiments the output gratings may be configured with a pitch satisfying one of the above cited conditions for λ=450 nm. In some embodiments the output gratings may be configured with a pitch satisfying one of the above cited conditions for λ=500 nm.

By way of example, in embodiment where the MRF angle γ=c·Γ that should be free of once-diffracted ambient light of wavelength k is 60 degrees, the pitch of the output gratings could be about 0.54λ or less. If the MRF angle γ is 45 degrees, the pitch of the output gratings could be about 0.6λ or less. If the MRF angle γ is 30 degrees, the pitch of the output gratings could be about ⅔λ or less. If the MRF angle γ is 20 degrees, the pitch of the output gratings could be about 0.745λ or less. For blue light with wavelength of 450 nm, the corresponding values may be about 241 nm, 263 nm, 300 nm, and 335 nm, respectively.

As follows from equations (7), the inner radius of the TIR ring in the k-plane depends on the wavelength λ, and thus the TIR rings 500 for light of different wavelength may only partially overlap, or not overlap at all, depending on the wavelengths and the refractive index of the waveguide. The greater the refractive index of the waveguide, the broader is the range of in-plane k-vectors in which two different wavelengths of image light may be coupled by the waveguide and guided to the eyebox, and therefore the broader is the FOV that the display system employing the waveguide can support.

FIG. 12 illustrates TIR rings 500B and 500R for two different wavelengths or color bands of visible light. The TIR ring for light of a first wavelength λ=λ_{R} is schematically indicated at 500R while a TIR ring for light of a second, shorter wavelength λ=λ_{B}<λ_{R} is schematically indicated at 500B. The long-wavelength TIR ring 500R is bounded by a TIR circle 501R and a maximum-angle circle 502R, which radii are defined by equations (7) for λ=λ_{R}. The shorter-wavelength light TIR ring 500B is bounded by a TIR circle 501B and a maximum-angle circle 502B, which radii are defined by equations (7) for λ=λ_{B}. By way of example the longer wavelength λ_{R} may correspond to red light, with the wavelength e.g. of 635 nm, while the shorter wavelength may correspond to blue light, with the wavelength e.g. of 465 nm. In the illustrated example the TIR rings 500R and 500B share a sub-ring 511, which may be referred to as a polychromatic TIR ring, and which width is defined by a following condition (13):

$$\frac{2 π}{{λ}_{B}} < \vert {k}_{c p l} \vert < \frac{2 π}{{λ}_{R}} n \cdot sin ( {β}_{max} ) \qquad ( 13 )$$

The width of the polychromatic TIR ring 511, which limits the FOV that may be supported at the two wavelengths simultaneously, increases as the refractive index n of the waveguide rises above a minimum value of λ_{R}/λ_{B}.

In some embodiments, a single waveguide made of optically transparent high-index material may be used in a display system to convey multiple color channels of RGB light from an image source to an eyebox of a NED, with the same input and output gratings used for at least one of the Red and Green color channels, as well as the Blue color channel. In some embodiments a condition on a minimum value of the refractive index n of the waveguide may be estimated by requiring that the in-coupler grating couples rays of the longest-wavelength color channel (Red) incident at corners of the FOV into the waveguide. This corresponds to a condition

$$\frac{{λ}_{R}}{{p}_{0}} + sin ( \frac{Γ}{2} ) \leq n \cdot sin ( {β}_{max} ) \qquad ( 14 )$$

where p₀ is the pitch of the in-coupler, and Γ is a width of the FOV in the direction of the diffraction vector of the in-coupler. A corresponding condition on the refractive index n may be expressed as

$$n > \frac{1}{sin ( {β}_{max} )} [ \frac{{λ}_{R}}{{p}_{0}} + sin ( \frac{Γ}{2} ) ] . \qquad ( 15 )$$

By way of example, to fully support a 60×40 degrees rectangular 2D FOV, which corresponds to Γ=72 degrees when the grating vector of the in-coupler is directed along a diagonal of the FOV, for λ_{R}=650 nm, p₀=300 nm, and βmax=75 degrees, the refractive index n of the waveguide should exceed 2.8. In some embodiments slight vignetting of images at a corner of a rectangular 2D FOV may be allowed without significantly degrading the viewer's experience. By way of a corresponding example, a waveguide with the refractive index n˜2.6 may support a 60×40 degrees 2D FOV in embodiments where some loss of the red spectrum is allowed at a corner of the FOV, starting about 20-25 degrees away from the center of the FOV.

In some embodiments, a single waveguide made of optically transparent high-index material with the refractive index of about 2.3, or preferably 2.4 or greater may be used in a display system to convey RGB light from an image source to an eyebox of a NED. In some embodiments, a single waveguide made of optically transparent high-index material with the refractive index of about 2.5-2.6 or greater may be used.

FIGS. 13A, 13B, and 13C illustrate coupling of image light of red, green, and blue color channels, respectively, into a waveguide configured for conveying polychromatic RGB light from an image light source to an eyebox, such as the waveguide 210, 410, or 710 described above. In the illustrated example the waveguide has a refractive index n=2.6. Each of the figures illustrate an in-plane k-space that is normalized to 2π/λ, so that the radius of the inner TIR circle is 1, the radius of the outer circle is n·sin(βₘₐₓ). The normalized grating vector of the waveguide's in-coupler is indicted at 830, and has a length g₀·λ/2π that scales with the wavelength. In the illustrated example the grating vectors g_{1,2} of the waveguide's out-couplers are of the same length and are oriented at +\−60° to the in-coupler grating; they may have different lengths and orientations in other embodiments. Shaded areas 815 indicate total 2D FOV supported by the waveguide for each of the three color bands, i.e. the in-plane k-vectors of all light rays that the waveguide conveys from the input to the output while conserving the propagation direction. Shaded areas 820 indicate the corresponding k-vectors of light coupled by the waveguide. An example rectangular 2D FOV that may be supported for all three colors, with some corner vignetting, is indicated at 810. In the illustrated example, the 2D RGB FOV 810 may be 40 by 60 degrees, with 72° diagonal, which corresponds to +\−20° horizontal FOV (H-FOV), +\−30° vertical FOV (V-FOV), and +\−36° diagonal FOV (D-FOV).

In the embodiment described above with reference to FIGS. 13A-13B, the pitch pᵢ of the grating vectors g_{1,2} of the out-couplers that is equal to about 280 nm may satisfy condition (12B) for blue ambient light, λ=450 nm, with c=1 and Γ defined by the D-FOV, or 72° in the illustrated example. In other embodiments the pitch pᵢ of the grating vectors g_{1,2} of the waveguide's out-couplers may satisfy condition (12B) for a somewhat smaller portion of the target FOV, for example within 80-90% thereof, allowing for greater pitch values of out-coupler gratings.

In some embodiments two or more waveguides may be stacked one over the other, with the input and output gratings of the waveguides that may be optimized for different wavelength ranges. In some embodiments, a stack of three waveguides may be used, one per color of RGB light. In some embodiments, one or more of the colors may be conveyed over two different waveguides. In some embodiments, a stack of two waveguides may be used to convey RGB light, so that one of the waveguides conveys light of two of the three color bands, for example Red and Green, and the other conveys the remaining color band, for example Blue. In some embodiments light of the green color band may be carried by both waveguides. In some embodiments, the output gratings of each waveguide may be configured to satisfy condition (9) with the scaling factor according to equations (10) or (12) for at least a portion of visible spectrum, so as to reduce ambient light leakage into a pre-defined fraction of the supported FOV of the display.

Referring to FIG. 14, there is illustrated a waveguide assembly 900 comprised of a first waveguide 921 having a first in-coupler 931 and a first out-coupler 941, and a second waveguide 922 having a second in-coupler 932 and a second out-coupler 942. Waveguides 921, 922 are arranged to form a 2-waveguide stack in which the in-coupler 931 is optically aligned with the in-coupler 932, and the out-coupler 941 is optically aligned with the out-coupler 942. A small gap 504 may be provided between the waveguides to assist in TIR. The in-coupler 931 may be configured to collect image light 901 from a target FOV, and couple it into at least one of the two waveguides for conveying to the out-couplers via TIR. The image light 901 may include red color channel 901R, green color channel 901G, and red color channel 901R. A polychromatic FOV of the waveguide stack is comprised of all angles of incidence α for which each color channel of the input light 901 could be coupled into at least one of the waveguides of the stack by one of the in-couplers thereof, and then coupled out of the waveguide by one of the out-couplers toward an exit pupil 955, where an eyebox may be located. By spreading the input light 901 among the two waveguides of the stack, the waveguide assembly 900 may be configured to support a polychromatic FOV that is substantially equal or greater in width than a monochrome FOV of any one of the waveguides of the stack. In some embodiments the in-couplers and out-couplers of the waveguide assembly 900 may be configured to couple the blue light and the green light into the first waveguide 921, and the red light into the second waveguide 922. In some embodiments the in-couplers and out-couplers of the waveguide assembly 900 may be configured to couple the green color channel into both the first waveguide 921 and the second waveguide 922, so that the green image light may be guided to an exit pupil 955 within either one of the two waveguides 921, 922, depending on the angle of incidence. In some embodiments, the out-couplers 941, 942 may be configured to satisfy conditions (8) or (12B) in at least a portion of visible spectrum, so as to reduce the diffraction of ambient light into a pre-defined fraction of the supported FOV of the display.

FIG. 15A schematically illustrates an example layout of a binocular near-eye display (NED) 1000 that includes two waveguide assemblies 1010 supported by a frame or frames 1015. Each of the waveguide assemblies 1010 is configured to convey image light from a display projector 1060 to a different eye of a user. The in-couplers 1030 may be provided with a common micro-display projector or two separate micro-display projectors 1060, which may be disposed to project image light toward the corresponding in-couplers 1030. Waveguide assemblies 1010 may each be in the form of, or include, a single waveguide that may be configured to guide polychromatic light in a target FOV as described above. Each waveguide includes an in-coupler 1030 and an out-coupler 1040, with each in-coupler diagonally aligned with the corresponding out-coupler. In other embodiments the placement of the in-couplers 1030 in the periphery of the corresponding out-couplers 1040 may be different. Each out-coupler 1040 includes an eyebox projection area 1051, which may also be referred to as the exit pupil of the waveguide, and from which in operation the image light is projected to an eye of the user. An eye box is a geometrical area where a good-quality image may be presented to a user's eye, and where in operation the user's eye is expected to be located. The eyebox projection areas 1051 may be disposed on an axis 1001 that connects their centers. The axis 1001 may be suitably aligned with the eyes of the user wearing the NED, or be at least parallel to a line connecting the eyes of the user, and may be referred to as the horizontal axis (x-axis). The in-couplers 1030 may be in the form of diffraction gratings with grating vectors g₀ that may be directed generally toward the eyebox projection areas 1351 of respective waveguide assemblies. Each out-coupler 1040 may be in the form of two diffraction gratings, with the grating vectors g₁ and g₂ of the respective gratings oriented at an angle to each other. These gratings may be disposed at opposing faces of each waveguide, or superimposed at one of the waveguide faces or in the bulk of the waveguide. The gratings of the in-coupler and out-coupler may be configured to satisfy a vector diagram illustrated in FIG. 15B. In some embodiments each waveguide assembly 1010 may be in the form of, or include, a waveguide stack with two or more waveguides as described above, with the grating vectors g₀, g₁ and g₂ that may be different in length for each waveguide of the stack and may be optimized for conveying different color channels. In some embodiments the gratings of each waveguide of the stack may be configured so at to avoid, or at least lessen, the leakage of once-diffracted ambient light into the supported FOV, or at least a pre-defined central portion of the supported FOV, as described above.

In embodiments with multiple output/redirecting gratings, such as those illustrated in FIGS. 3B, 4, 7, 14, 15A, undesired ambient light may also reach the eyebox after being diffracted by two or more output gratings in sequence. Accordingly, some embodiments may be configured to lessen the likelihood of the double-diffracted ambient light in the visible spectrum from reaching the eyebox after successive diffractions from the out-coupler gratings. In embodiments where the in-coupler and out-coupler gratings satisfy equation (5), i.e. sum substantially to zero, e.g. where g₀+g₁+g₂=0, successive diffractions from each of the output gratings is equivalent, in terms of a diffraction direction, to a diffraction from the in-coupler grating with a grating vector of (−g₀). Accordingly, in some embodiments the in-coupler grating may be configured with a pitch p₀ that also satisfies one or more of the conditions (8)-(10), and (12B) in the visible spectrum, or at least a portion thereof. In other words, in some embodiments one or more of the conditions on the grating pitch of the out-couplers 140, 240, 440, 941, 942 1040 may also apply to the grating pitch of the in-couplers 130, 230, 430, 930, 1030.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

Referring to FIG. 16A, an HMD 1100 is an example of an AR/VR wearable display system which encloses the user's face, for a greater degree of immersion into the AR/VR environment. The HMD 1100 may be an embodiment of the waveguide display 100 of FIG. 1A or the NED 1000 of FIG. 15A, for example. The function of the HMD 1100 is to augment views of a physical, real-world environment with computer-generated imagery, and/or to generate the entirely virtual 3D imagery. The HMD 1100 may include a front body 1102 and a band 1104. The front body 1102 is configured for placement in front of eyes of a user in a reliable and comfortable manner, and the band 1104 may be stretched to secure the front body 1102 on the user's head. A display system 1180 may be disposed in the front body 1102 for presenting AR/VR imagery to the user. Sides 1106 of the front body 1102 may be opaque or transparent. The display system 1180 may include a display waveguide as described above coupled to image projectors 1114.

In some embodiments, the front body 1102 includes locators 1108 and an inertial measurement unit (IMU) 1110 for tracking acceleration of the HMD 1100, and position sensors 1112 for tracking position of the HMD 1100. The IMU 1110 is an electronic device that generates data indicating a position of the HMD 1100 based on measurement signals received from one or more of position sensors 1112, which generate one or more measurement signals in response to motion of the HMD 1100. Examples of position sensors 1112 include: one or more accelerometers, one or more gyroscopes, one or more magnetometers, another suitable type of sensor that detects motion, a type of sensor used for error correction of the IMU 1110, or some combination thereof. The position sensors 1112 may be located external to the IMU 1110, internal to the IMU 1110, or some combination thereof.

The locators 1108 are traced by an external imaging device of a virtual reality system, such that the virtual reality system can track the location and orientation of the entire HMD 1100. Information generated by the IMU 1110 and the position sensors 1112 may be compared with the position and orientation obtained by tracking the locators 1108, for improved tracking accuracy of position and orientation of the HMD 1100. Accurate position and orientation is important for presenting appropriate virtual scenery to the user as the latter moves and turns in 3D space.

The HMD 1100 may further include a depth camera assembly (DCA) 1111, which captures data describing depth information of a local area surrounding some or all of the HMD 1100. To that end, the DCA 1111 may include a laser radar (LIDAR), or a similar device. The depth information may be compared with the information from the IMU 1110, for better accuracy of determination of position and orientation of the HMD 1100 in 3D space.

The HMD 1100 may further include an eye tracking system for determining orientation and position of user's eyes in real time. The determined position of the user's eyes allows the HMD 1100 to perform (self-) adjustment procedures. The obtained position and orientation of the eyes also allows the HMD 1100 to determine the gaze direction of the user and to adjust the image generated by the display system 1180 accordingly. In one embodiment, the vergence, that is, the convergence angle of the user's eyes gaze, is determined. The determined gaze direction and vergence angle may also be used for real-time compensation of visual artifacts dependent on the angle of view and eye position. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1102.

Referring to FIG. 16B, an AR/VR system 1150 may be an example implementation of the waveguide display 100 of FIG. 1A, or the NED 1000 of FIG. 16A. The AR/VR system 1150 includes the HMD 1100 of FIG. 16A, an external console 1190 storing various AR/VR applications, setup and calibration procedures, 3D videos, etc., and an input/output (I/O) interface 1115 for operating the console 1190 and/or interacting with the AR/VR environment. The HMD 1100 may be “tethered” to the console 1190 with a physical cable, or connected to the console 1190 via a wireless communication link such as Bluetooth®, Wi-Fi, etc. There may be multiple HMDs 1100, each having an associated I/O interface 1115, with each HMD 1100 and I/O interface(s) 1115 communicating with the console 1190. In alternative configurations, different and/or additional components may be included in the AR/VR system 1150. Additionally, functionality described in conjunction with one or more of the components shown in FIGS. 16A and 16B may be distributed among the components in a different manner than described in conjunction with FIGS. 16A and 16B in some embodiments. For example, some or all of the functionality of the console 1115 may be provided by the HMD 1100, and vice versa. The HMD 1100 may be provided with a processing module capable of achieving such functionality.

As described above with reference to FIG. 16A, the HMD 1100 may include an eye tracking system 1125 for tracking eye position and orientation, determining gaze angle and convergence angle, etc., the IMU 1110 for determining position and orientation of the HMD 1100 in 3D space, the DCA 1111 for capturing the outside environment, the position sensor 1112 for independently determining the position of the HMD 1100, and the display system 1180 for displaying AR/VR content to the user. The display system 1180 includes (FIG. 16B) one or more image projectors 1114, such as one or more scanning projectors or one or more electronic displays, including but not limited to a liquid crystal display (LCD), an organic light emitting display (OLED), an inorganic light emitting display (ILED), an active-matrix organic light-emitting diode (AMOLED) display, a transparent organic light emitting diode (TOLED) display, a projector, or a combination thereof. The display system 1180 further includes a display waveguide 1130, whose function is to convey the images generated by the image projector 1114 to the user's eye. The display system 1180 may further include an optics block 1135, which may in turn include various lenses, e.g. a refractive lens, a Fresnel lens, a diffractive lens, an active or passive Pancharatnam-Berry phase (PBP) lens, a liquid lens, a liquid crystal lens, etc., a pupil-replicating waveguide, grating structures, coatings, etc. In some embodiments the optics block 1135 may include a varifocal functionality e.g. to compensate for vergence-accommodation conflict, to correct for vision defects of a particular user, to offset aberrations, etc.

The I/O interface 1115 is a device that allows a user to send action requests and receive responses from the console 1190. An action request is a request to perform a particular action. For example, an action request may be an instruction to start or end capture of image or video data or an instruction to perform a particular action within an application. The I/O interface 1115 may include one or more input devices, such as a keyboard, a mouse, a game controller, or any other suitable device for receiving action requests and communicating the action requests to the console 1190. An action request received by the I/O interface 1115 is communicated to the console 1190, which performs an action corresponding to the action request. In some embodiments, the I/O interface 1115 includes an IMU that captures calibration data indicating an estimated position of the I/O interface 1115 relative to an initial position of the I/O interface 1115. In some embodiments, the I/O interface 1115 may provide haptic feedback to the user in accordance with instructions received from the console 1190. For example, haptic feedback can be provided when an action request is received, or the console 1190 communicates instructions to the I/O interface 1115 causing the I/O interface 1115 to generate haptic feedback when the console 1190 performs an action.

The console 1190 may provide content to the HMD 1100 for processing in accordance with information received from one or more of: the IMU 1110, the DCA 1111, the eye tracking system 1125, and the I/O interface 1115. In the example shown in FIG. 16B, the console 1190 includes an application store 1155, a tracking module 1160, and a processing module 1165. Some embodiments of the console 1190 may have different modules or components than those described in conjunction with FIG. 16B. Similarly, the functions further described below may be distributed among components of the console 1190 in a different manner than described in conjunction with FIGS. 16A and 16B.

The application store 1155 may store one or more applications for execution by the console 1190. An application is a group of instructions that, when executed by a processor, generates content for presentation to the user. Content generated by an application may be in response to inputs received from the user via movement of the HMD 1100 or the I/O interface 1115. Examples of applications include: gaming applications, presentation and conferencing applications, video playback applications, or other suitable applications.

The tracking module 1160 may calibrate the AR/VR system 1150 using one or more calibration parameters and may adjust one or more calibration parameters to reduce error in determination of the position of the HMD 1100 or the I/O interface 1115. Calibration performed by the tracking module 1160 also accounts for information received from the IMU 1110 in the HMD 1100 and/or an IMU included in the I/O interface 1115, if any. Additionally, if tracking of the HMD 1100 is lost, the tracking module 1160 may re-calibrate some or all of the AR/VR system 1150.

The tracking module 1160 may track movements of the HMD 1100 or of the I/O interface 1115, the IMU 1110, or some combination thereof. For example, the tracking module 1160 may determine a position of a reference point of the HMD 1100 in a mapping of a local area based on information from the HMD 1100. The tracking module 1160 may also determine positions of the reference point of the HMD 1100 or a reference point of the I/O interface 1115 using data indicating a position of the HMD 1100 from the IMU 1110 or using data indicating a position of the I/O interface 1115 from an IMU included in the I/O interface 1115, respectively. Furthermore, in some embodiments, the tracking module 1160 may use portions of data indicating a position or the HMD 1100 from the IMU 1110 as well as representations of the local area from the DCA 1111 to predict a future location of the HMD 1100. The tracking module 1160 provides the estimated or predicted future position of the HMD 1100 or the I/O interface 1115 to the processing module 1165.

The processing module 1165 may generate a 3D mapping of the area surrounding some or all of the HMD 1100 (“local area”) based on information received from the HMD 1100. In some embodiments, the processing module 1165 determines depth information for the 3D mapping of the local area based on information received from the DCA 1111 that is relevant for techniques used in computing depth. In various embodiments, the processing module 1165 may use the depth information to update a model of the local area and generate content based in part on the updated model.

The processing module 1165 executes applications within the AR/VR system 1150 and receives position information, acceleration information, velocity information, predicted future positions, or some combination thereof, of the HMD 1100 from the tracking module 1160. Based on the received information, the processing module 1165 determines content to provide to the HMD 1100 for presentation to the user. For example, if the received information indicates that the user has looked to the left, the processing module 1165 generates content for the HMD 1100 that mirrors the user's movement in a virtual environment or in an environment augmenting the local area with additional content. Additionally, the processing module 1165 performs an action within an application executing on the console 1190 in response to an action request received from the I/O interface 1115 and provides feedback to the user that the action was performed. The provided feedback may be visual or audible feedback via the HMD 1100 or haptic feedback via the I/O interface 1115.

In some embodiments, based on the eye tracking information (e.g., orientation of the user's eyes) received from the eye tracking system 1125, the processing module 1165 determines resolution of the content provided to the HMD 1100 for presentation to the user with the image projector(s) 1114. The processing module 1165 may provide the content to the HMD 1100 having a maximum pixel resolution in a foveal region of the user's gaze. The processing module 1165 may provide a lower pixel resolution in the periphery of the user's gaze, thus lessening power consumption of the AR/VR system 1150 and saving computing resources of the console 1190 without compromising a visual experience of the user. In some embodiments, the processing module 1165 can further use the eye tracking information to adjust where objects are displayed for the user's eye to prevent vergence-accommodation conflict and/or to offset optical distortions and aberrations.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

We claim:

1. A waveguide for conveying image light from an image light source to an eyebox with a target field of view (FOV) spanning an angular range Γ, the waveguide comprising:
a substrate for propagating the image light therein by total internal reflection;
an input coupler supported by the substrate and configured to couple the image light into the waveguide; and,
an output coupler supported by the substrate and configured to couple the image light out of the waveguide for propagating toward the eyebox;
wherein the output coupler comprises a first output grating having a pitch p₁ that does not exceed
$$\frac{λ}{1 + sin ( 0.8 \cdot Γ \text{/} 2 )} ,$$
wherein λ is a wavelength of blue light.

2. The waveguide of claim 1, wherein
$${p}_{1} \leq \frac{λ}{1 + sin ( Γ \text{/} 2 )} .$$

3. The waveguide of claim 1, wherein the substrate has a refractive index of at least 2.3.

4. The waveguide of claim 1, wherein the output coupler further comprises a second output grating configured to cooperate with the first output grating to diffract the image light out of the waveguide, and wherein the second output grating has a pitch p₂ that does not exceed p₁.

5. The waveguide of claim 4, wherein the input coupler comprises an input grating having a pitch p₀ that does not exceed p₁.

6. The waveguide of claim 4, wherein the first output grating and the second output grating cooperate for diffracting the image light out of the waveguide at an output angle equal to an angle of incidence thereof upon the waveguide.

7. The waveguide of claim 4, wherein the first and second output gratings are disposed at opposite faces of the waveguide.

8. The waveguide of claim 1, wherein the waveguide is configured for conveying to the eyebox at least one of a red color (R) channel and a green color (G) channel.

9. The waveguide of claim 1, wherein λ is equal or smaller than 450 nm.

10. The waveguide of claim 1, wherein p₁≤300 nm.

11. The waveguide of claim 1, wherein the eyebox extends over a length 2a in a first direction, wherein the first output grating extends over a length 2b in the first direction and is disposed at a distance d from the eyebox; and wherein the pitch p₁ does not exceed
$$\frac{λ}{1 + sin ( {θ}_{m} )}$$
wherein θₘ=atan[(b+a)/d].

12. A near-eye display (NED) device comprising:
a light source configured to emit image light comprising a plurality of color channels; and,
a waveguide optically coupled to the light source and configured to convey a portion of the image light from the light source to an eyebox within a target field of view (FOV) spanning an angular range Γ, the waveguide comprising:
an input coupler for receiving the portion of the image light; and,
an output coupler for coupling the portion out of the waveguide toward the eyebox;
wherein the output coupler comprises a first output grating having a pitch p₁ that does not exceed
$$\frac{λ}{1 + sin ( 0.8 \cdot Γ \text{/} 2 )} ,$$
wherein λ is a wavelength of blue light.

13. The NED device of claim 12, wherein the waveguide comprises dielectric material with an index of refraction of at least 2.3.

14. The NED device of claim 13, wherein the output coupler further comprises a second output grating configured to cooperate with the first output grating to diffract the image light out of the waveguide at an output angle equal to an incidence angle of the image light upon the input coupler, wherein the second output grating has a pitch not exceeding p₁.

15. The NED device of claim 14, wherein λ is a wavelength of blue light, and wherein the waveguide is configured to convey to the eyebox at least one of a red color channel of the image light or a green color channel of the image light.

16. The NED device of claim 14, wherein λ≤500 nm, and wherein the waveguide is configured to convey to the eyebox a red color channel of the image light with wavelengths equal or longer than 600 nm.

17. The NED device of claim 14, comprising a waveguide stack including the waveguide, wherein each waveguide of the waveguide stack comprises an output grating with a pitch of at most p₁.

18. A waveguide for conveying image light comprising a plurality of color channels from an image light source to an eyebox, the waveguide comprising:
a substrate for propagating the image light therein by total internal reflection;
an input coupler supported by the substrate for receiving the image light; and,
an output coupler supported by the substrate for coupling the image light out of the waveguide toward the eyebox;
wherein the output coupler comprises a first output grating having a pitch p that does not exceed 300 nm.

19. The waveguide of claim 18, wherein the substrate has an index of refraction of at least 2.3.

20. The waveguide of claim 19, wherein the waveguide is configured for conveying to the eyebox at least one of a red color (R) channel of the image light and a green color (G) channel of the image light.
